(19) United States
(12) Patent Application Publication
(10) Pub. No.: US 2011/0027678 A1
(43) Pub. Date: Feb. 3, 2011

(54) FUEL CELL SYSTEM AND METHOD FOR OPERATING A FUEL CELL SYSTEM

(75) Inventor: Ralf Nuessle, Heidenheim (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/933,708

(22) PCT Filed: Mar. 31, 2009
(86) PCT No.: PCT/EP09/02339

§ 371 Date: Sep. 21, 2010

(30) Foreign Application Priority Data
Apr. 1, 2008 (DE) 10 2008 016 578.6

(51) Int. Cl. H01M 8/04

(52) U.S. Cl. 429/428; 429/512

(57) ABSTRACT

The invention relates to a fuel cell apparatus (1) with at least one fuel cell (2) having an anode region (4) and a cathode region (3) and being accommodated in a housing (6), wherein a flushing medium for flushing the housing (6) can be introduced into a space (7) of the housing (6) outside the fuel cell (2), the flushing medium being an exhaust gas generated in the cathode region (3) in the operation of the fuel cell (2). The invention further relates to a method for the operation of a fuel cell apparatus (1) of this type.

The invention relates to a fuel cell apparatus with at least one fuel cell having an anode region and a cathode region and being accommodated in a housing. A flushing medium for flushing the housing can be introduced into the housing outside the fuel cell. The invention further relates to a method for the operation of a fuel cell apparatus wherein a flushing medium for flushing the housing which accommodates a fuel cell is introduced into the housing outside the fuel cell.

A fuel cell apparatus and a method of this type are known from WO 2005/099017 A2. In this specification ambient air is fed in from the outside as a flushing medium.

In fuel cell systems, the fuel cell or a fuel cell stack comprising several fuel cells is usually accommodated in a housing. On the one hand, this housing protects the fuel cell stack against external influences such as dirt, dust, water etc., while on the other hand it catches any leakas of the fuel cell stack, in particular of the anode, and the hydrogen emissions involved in such leaks and diverts them to a defined location in a controlled manner. This however involves the problem that the leakage of the fuel cell stack can generate gas mixtures within the housing which may be flammable or explosive owing to their composition. In prior art, attempts to avoid this are based on flushing the housing continuously with fresh air fed into the housing from the environment by a fan or ventilator. In this context, the fan of the fuel cell system according to WO 2005/099017 A2 also supplies air to the cathode. Adjacent to the inlet line, a discharge line is provided on the housing, which may for example terminate into a discharge air or exhaust passage. The continuous flushing of the housing with fresh air is meant to ensure that no undesirable hydrogen/air mixture is formed in the housing. This however poses the problem that an additional separate fan has to be provided for implementing the flow through the housing. This fan has to be driven by a motor, which has a negative effect on the overall efficiency of the system while not making any contribution to energy conversion. The fan usually has a limited power and can only deliver a defined, relatively small air flow, which makes continuous operation necessary.

Within the housing, a sensor may further be provided to measure the hydrogen concentration in the housing. If this concentration exceeds a defined limit value, the whole fuel cell system is switched off, as the fan may no longer be able to deliver sufficient air to lower the hydrogen concentration in the housing. Flushing with ambient air also has further disadvantages, because it contains approximately 21% oxygen, which in the end forms a component of the gas mixture which is potentially explosive at a certain hydrogen concentration. In addition, the noise emission of a continuously running fan may be found uncomfortable if the vehicle is at a standstill and the noise is not covered acoustically by other noises.

In this context, fuel cell systems are known in which, for example downstream of an air filter unit, a line terminating into the housing branches off the induction section of the compressor for the cathode region of the fuel cell system. This line likewise accommodates a fan which conveys the branched-off air into the housing. The medium which is then discharged from the housing is fed into the induction section for the cathode region upstream of the compressor. The gas mixture of the housing is therefore fed to the compressor, which draws the gas mixture in and feeds it into the cathode section of the fuel cell. The possibly very small proportion of hydrogen which is discharged from the housing in this process is then diluted by the air drawn by the compressor from the environment. The gas flow is then compressed and fed to the cathode, where the very small proportion of hydrogen reacts chemically. This is meant to ensure that there is no hydrogen emission into the external environment. The explanations given above apply to the fan in this branch line; here, too, the fan operates continuously at a fixed point and the housing is flushed continuously.

The present invention is based on the problem of creating a fuel cell apparatus and a method for the operation of a fuel cell apparatus, wherein the housing can be flushed efficiently outside the fuel cell without any unpleasant noise emissions being caused by a separately provided fan, and wherein moreover no undesirable fuel/oxidant mixture is created by the flushing process.

This problem is solved by a fuel cell apparatus with the features of claim 1 and by a method with the features of claim 21.

A fuel cell apparatus according to the invention comprises at least one fuel cell having an anode region and a cathode region. In addition, the fuel cell apparatus comprises a housing in which the fuel cell is accommodated. The fuel cell apparatus is moreover designed such that a flushing medium for flushing the housing can be introduced into the housing outside the fuel cell. The flushing medium is an exhaust gas generated in the cathode region during the operation of the fuel cell. This design of the fuel cell apparatus allows for a flushing process which avoids the formation of an undesirable fuel/oxidant mixture in the housing outside the fuel cell. Undesirable flammable or explosive gas mixtures can therefore be avoided in the flushing process.

Owing to the fuel cell apparatus according to the invention, it is no longer necessary to provide a separate fan for ventilating the housing. Instead, the exhaust air applied to the fuel cell outlet of the cathode can be used for ventilation. This is particularly advantageous because it involves depleted air which, as a result of the electrochemical conversion in the fuel cell, has an oxygen content which is significantly below 21% (the proportion of oxygen in fresh ambient air is approximately 21%) and an increased nitrogen content higher than 70% (the proportion of nitrogen in fresh ambient air is approximately 70%). This means that more inert gas is fed into the housing, which can significantly reduce the probability of the formation of an undesirable gas mixture. Alternatively, a lower overall flushing medium volume can be used, which has a positive effect on the efficiency of the fuel cell apparatus.

The fuel cell apparatus preferably includes a device for detecting the fuel concentration in the housing outside the fuel cell. This device is preferably located inside the housing and outside the fuel cell. The device may in particular be provided with at least one sensor for concentration detection. With this device, the hydrogen concentration can be measured at least intermittently and preferably continuously, permitting continuous checks whether the hydrogen concentration and thus the fuel concentration in the housing outside the fuel cell is too high and whether this housing region has to be flushed. As a result, the interior of the housing outside the fuel cell does not have to be flushed continuously, but the flushing process can be initiated as required. The cathode exhaust gas can therefore preferably be introduced in a situation-specific manner, in particular in dependence on the fuel concentration in the housing outside the fuel cell.

The fuel cell apparatus in particular comprises a flushing medium supply line branching off an exhaust line of the cathode region and terminating into the housing. The exhaust gas generated in the cathode region can therefore be carried off via the exhaust line in a simple and cost-effective manner and at least partially be introduced into the housing via the flushing medium supply line in a simple and cost-effective manner.

The flushing medium supply line preferably branches off the exhaust line downstream of a separator connected to the exhaust line of the cathode region as viewed in the direction of flow of the cathode region exhaust gas. This is particularly advantageous, because the cathode exhaust gas is removed downstream of a separator and has therefore no longer an unnecessarily high moisture content. As a separator is provided for the dehumidification of the exhaust gas, there is a particularly dry exhaust gas flow downstream of the separator, allowing particularly dry exhaust gas to be fed into the housing via the flushing medium supply line.

A bypass line terminating into the exhaust line downstream of the point where the flushing medium supply line branches off the exhaust line of the cathode region preferably branches off the separator. This creates a kind of bypass device bypassing the branch-off of the flushing medium supply line from the exhaust line. Owing to this arrangement, flow-specific processes can be suitably adjusted with respect to which proportion of the exhaust gas flow is directed into the environment and which proportion is directed into the flushing medium supply line.

The flushing medium supply line preferably runs within the housing. In a particularly expedient design, the flushing medium supply line is completely accommodated in the housing and runs completely within it. In such a variant, the flushing medium supply line therefore branches off the exhaust line within the housing and outside the fuel cell, and the outlet of the flushing medium supply line is also located in the interior of the housing outside the fuel cell. This allows for a compact construction and component integration in the housing. Last but not least, the components can be arranged suitably in terms of space reduction and can moreover be protected against dirt etc.

Alternatively, it may be provided that the flushing medium supply line branches off the exhaust line outside the housing and runs outside the housing. In this context, the flushing medium supply line is completely located outside the housing and connected to the housing only at the termination.

It may also be provided that the separator is located in the housing or outside the housing. This too allows for a construction- and demand-specific mounting of the separator and flushing medium supply line components.

A unit for reducing the flow cross-section, in particular a valve or a restrictor, is preferably installed into the flushing medium supply line. This unit for reducing the flow cross-section and the device for the detection of the fuel concentration are preferably connected to a logic and/or control unit in a manner suitable for conducting signals or data. This is a particularly advantageous development in that it allows for a highly precise and efficient adjustment of the exhaust gas flow fed into the interior of the housing via the flushing medium supply line.

The fuel cell apparatus moreover preferably comprises a medium discharge line for discharging the medium mixture from the housing. This medium discharge line preferably terminates into a supply line for the supply of oxidants to the cathode region. The medium discharge line preferably terminates into the supply line upstream of a handling unit, in particular a fan or compressor, as viewed in the direction of oxidant flow.

In an advantageous manner, the fuel cell apparatus comprises a branch line branching off the supply line to the cathode region. The branch line terminates into the housing outside the fuel cell. This branch line may be completely accommodated within the housing. Alternatively, it may be provided that the branch line branches off the supply line outside the housing and terminates into the housing at the outside. In this design, the branch line is located virtually completely outside the housing.

The branch line preferably branches off the supply line downstream of a handling unit connected to the supply line.

A unit for reducing the flow cross-section may be located or provided in the branch line as well.

Depending on the fuel concentration which is in particular detected by a suitable sensor system, the unit for reducing the flow cross-section in the flushing medium supply line will be controlled in the interior of the housing and outside the fuel cell by the logic and/or control unit in such a way that the exhaust gas to be fed into the housing is supplied in terms of volume and/or of time. This process in particular runs until a presettable threshold value for this fuel concentration in the housing outside the fuel cell is no longer exceeded. This offers the special advantage that the housing is flushed only as required, i.e. at a defined fuel concentration in the housing, and not continuously. This further offers the opportunity to react to undesirable major leakages. It is also possible to use the whole of the exhaust gas of the cathode region for flushing and to introduce the complete exhaust gas flow from the cathode region into the housing via the flushing medium supply line. At temporary peak concentrations of fuel in the housing, for example, the flushing flow can be increased for the reaction of the cathode exhaust gas.

There is therefore no need for an additional fan and for the drive unit required to drive the former, so that the overall efficiency of the fuel cell apparatus is not affected unnecessarily and costs, weight and spatial requirements can be reduced.

In the method according to the invention for the operation of a fuel cell apparatus with at least one fuel cell having an anode region and a cathode region and being accommodated in a housing, a flushing medium for flushing the housing is introduced into the housing outside the fuel cell. The flushing medium introduced into the housing is an exhaust gas generated in the cathode region during the operation of the fuel cell. The advantages offered by this method have already been described above in the context of the fuel cell system or apparatus according to the invention.

The cathode exhaust gas is expediently introduced into the housing in terms of volume and/or time in dependence on a fuel concentration detected outside the fuel cell in the housing. Both the time-specific and the volume-specific supply of the cathode exhaust gas into the housing can be controlled very efficiently in this way and precisely matched to demand.

Advantageous further developments of the fuel cell apparatus according to the invention should also be considered as advantageous further developments of the method according to the invention.

Embodiments of the invention are explained in greater detail below with reference to the diagrammatic drawings, of which:

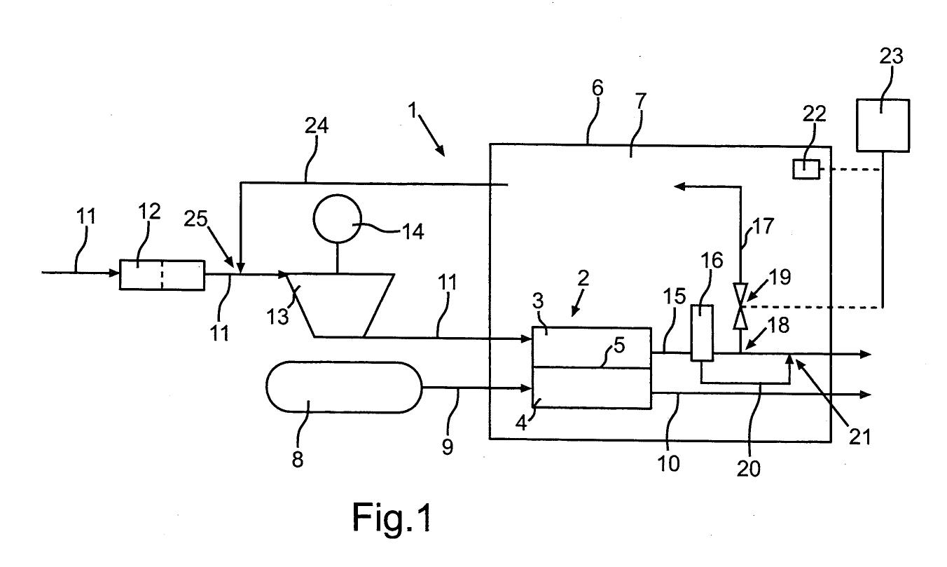

FIG. 1 shows a first embodiment of a fuel cell apparatus according to the invention;

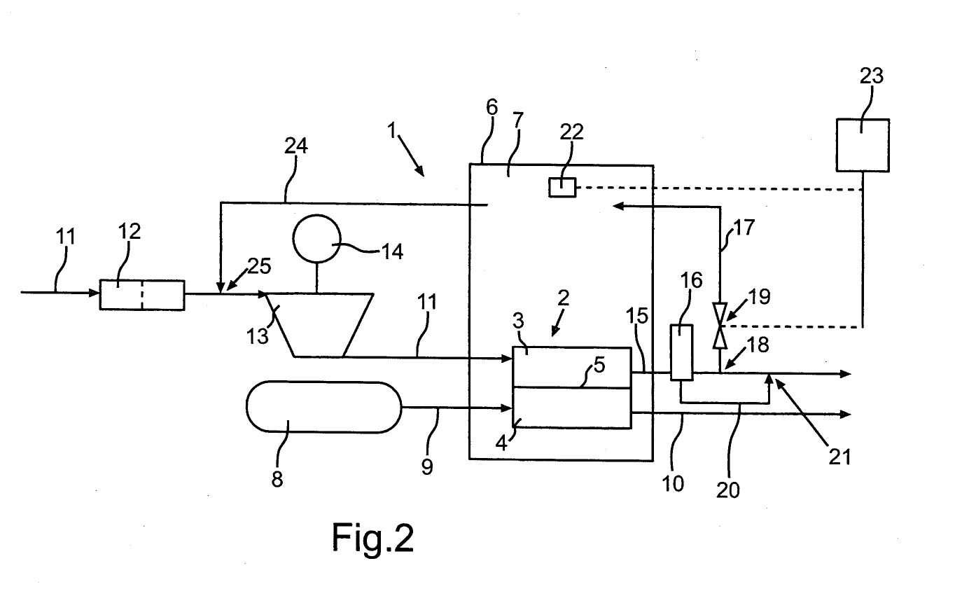

FIG. 2 shows a second embodiment of a fuel cell apparatus according to the invention;

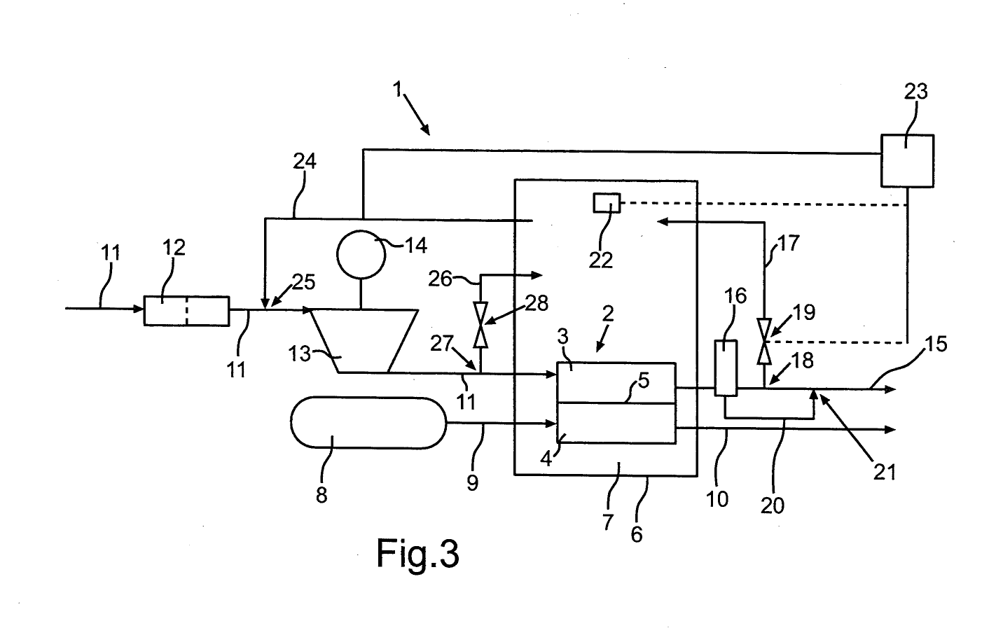

FIG. 3 shows a third embodiment of a fuel cell apparatus according to the invention; and

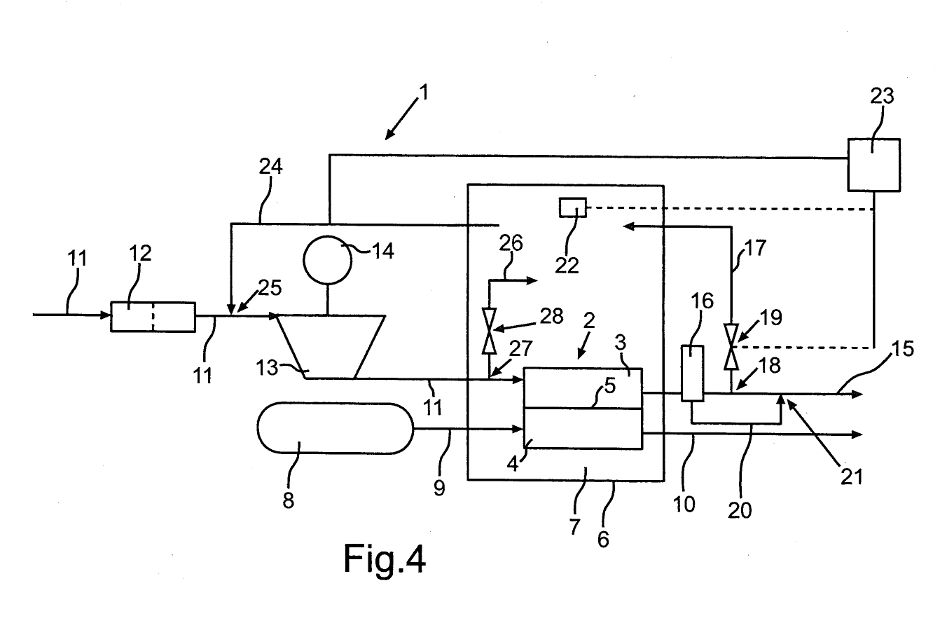

FIG. 4 shows a fourth embodiment of a fuel cell apparatus according to the invention.

Identical elements or elements of identical function are identified by the same reference numbers in the figures.

FIG. 1 shows a first embodiment of a fuel cell apparatus 1 according to the invention, which is designed as a mobile fuel cell system. The fuel cell apparatus 1 is installed into a vehicle. The fuel cell system or the fuel cell apparatus 1 comprises at least one fuel cell 2, preferably a fuel cell stack with a plurality of such fuel cells 2. The fuel cell 2 is designed as a PEM (proton exchange membrane) fuel cell. The fuel cell 2 comprises a cathode region 3 and an anode region 4 separated from each other by a PEM 5. The fuel cell 2 is accommodated in a housing 6 dimensioned such that a free space 7 forming the interior of the housing 6 is created outside the fuel cell 2.

Concerning the representation of the fuel cell apparatus 1, it should be emphasised that only the components required for explanation are shown, but the fuel cell apparatus 1 may comprise a multitude of additional, components not shown in the drawing.

The fuel cell apparatus 1 further comprises a reservoir 8 containing the fuel, in particular hydrogen or a hydrogen-containing gas. This fuel is supplied to the anode region 4 via a supply line 9. An exhaust gas generated in the anode region 4 in the operation of the fuel cell apparatus 1 is drawn from the anode region 4 via an exhaust line 10 and discharged into the environment from the housing 6 and from the fuel cell apparatus 1. The reservoir 8, the supply line 9 and the discharge or exhaust line 10 are assigned to an anode branch of the fuel cell 2.

The fuel cell apparatus 1 further comprises a cathode branch. A supply line 11 for supplying an oxidant, in particular oxygen or an oxygen-containing gas such as air, to the cathode region 3 is assigned to this cathode branch. The supply line 11 leading to the cathode region 3 is connected to an air filter 12. In addition, the supply line 11 is connected to a compressor 13 driven by a motor 14. This compressor 14 delivers the oxidant to the cathode region 3.

The fuel cell apparatus 1 moreover comprises an exhaust line 15 assigned to the cathode branch, through which the exhaust gas generated in the cathode region 3 during the operation of the fuel cell 2 is discharged into the environment from the housing 6 and from the fuel cell apparatus 1.

In the fuel cell apparatus 1 shown in FIG. 1, a separator 16 is provided inside the housing 6 and outside the fuel cell 2 and either connected to or located in the exhaust line 15.

Downstream of the separator 16, a flushing medium supply line 17 branches off the exhaust line 15 at a branch point 18. The flushing medium supply line 17 accommodates a unit 19 for reducing the flow cross-section, for example a valve, a restrictor or the like.

The flushing medium supply line 17 terminates into the interior or free space 7. According to the representation of FIG. 1, the flushing medium supply line 17 is likewise completely accommodated in the housing 6.

A bypass line 20 branching off the separator 16 and terminating downstream of the branch point 18 at the inlet 21 into the exhaust line 15 is provided as a bypass device for bypassing the branch point 18. It is provided for the discharge of the fluid collected in the separator 16.

The fuel cell apparatus 1 further comprises a device 22 for detection the fuel concentration, in particular the hydrogen concentration, in the free space 7. This device 22 is preferably designed as a sensor or a unit comprising several sensors. The device 22 and the unit 19 are connected to a logic and/or control unit 23 in a manner suitable for conducting signals or data. The device 22 is completely accommodated within the housing 6 and outside the fuel cell 2 and is preferably disposed near the top cover of the housing 6 with respect to the level of the fuel cell 2.

In addition, the fuel cell apparatus 1 comprises a medium discharge line 24 through which the medium mixture formed in the free space 7 is discharged from the housing 6. The medium mixture in particular contains the flushing medium, i.e. the cathode exhaust gas, and any fuel which may be present in the free space 7.

The medium discharge line 24 terminates at the inlet 25 into the supply line 11. The medium discharge line 24 therefore terminates upstream of the main compressor 13 into the supply line 11.

Depending on the fuel concentration detected in the free space 7 by the sensor or the device 22, the unit 19 is opened or closed by the logic and/or control unit 23. Just when a preset limit value for the fuel concentration in the free space 7 is exceeded, the unit 19 can be opened completely or at least partially. This allows the metered supply of cathode exhaust gas via the flushing medium supply line 17 as adjusted by the logic and/or control unit 23. The volume of cathode exhaust gas and/or the duration of the supply of cathode exhaust gas to the free space 7 can therefore be adjusted very precisely and matched to demand.

In this context, it may be provided that only a part of the cathode exhaust gas flowing through the exhaust line 15 is fed into the free space 7 via the flushing medium supply line 17. It is however also possible to introduce the entire cathode exhaust gas flow into the free space 7 via the flushing medium supply line 17.

The air/hydrogen mixture which may be present in the free space 7 is in a manner of speaking diluted by this addition of cathode exhaust gas. This process may be intermittent or continuous. It will in particular run until the device 22 detects in the free space 7 a fuel concentration below, in particular significantly below, the preset limit value. In order not to introduce additional moisture and water vapour or water into the free space 7 of the housing 6, the separator 16 is provided, the branch point 18 being expediently located downstream of the separator 16, so that relatively dry exhaust gas flows are fed into the free space 7 via the flushing medium supply line 17. The separator 16 removes water or condensate from the exhaust gas flow. After air has been removed, i.e. downstream of the branch point 18, the water or condensate is once again added to the remaining exhaust air by being re-introduced into the exhaust line 15. It is then discharged into the environment via the bypass line 20.

FIG. 2 shows a further embodiment of a fuel cell apparatus 1, which differs from the embodiment shown in FIG. 1 in that the separator 16, the bypass line 20, the flushing medium supply line 17 and the unit 19 are located outside the housing 6.

FIG. 3 shows a further embodiment of a fuel cell apparatus 1. In contrast to the embodiment according to FIG. 2, a branch line 26 is provided in this embodiment. The branch line 26 branches off the supply line 11 at the branch point 27 upstream of the fuel cell 2 and downstream of the main compressor 13. The branch line 26 terminates into the housing 6 or the free space 7.

In the embodiment according to FIG. 3, the branch line 26 therefore runs virtually completely outside the housing 6. A unit 28 for reducing the flow cross-section of the branch line 26 is provided in the branch line 26. This unit 28 may be a valve, a restrictor or the like. This further development according to FIG. 3 offers a supplementary option for cases of leakage in the housing 6 if the fuel circuit is pressurised, which may happen in a start/stop operation of the fuel cell device 1, wherein the fuel is virtually “locked into” the fuel circuit. In such a situation, the main compressor 13 of the cathode branch and thus of the air circuit is switched off. If the fuel concentration in the housing 6 now exceeds the preset limit value, the compressor 13 is started for a short time. Compressed air can now be introduced into the housing 6 and the free space 7 via the unit 28 without having first to be fed through the cathode or the cathode region 3 of the fuel cell 2. The exhaust gas generated in the cathode region 3 nevertheless continues to be fed into the free space 7 via the flushing medium supply line 17 as required.

FIG. 4 shows a further embodiment which, in contrast to the embodiment shown in FIG. 3, is designed such that the branch line 26 is completely accommodated within the free space 7 of the housing 6.

The embodiment according to FIG. 1 can obviously likewise be provided with a branch line 26 with preferably a unit 28. In this case, the fuel cell apparatus 1 according to FIG. 1 may be designed such that this branch line 26 is located either outside the housing 6 as shown in FIG. 3 or inside the housing 6 as shown in FIG. 4.

In addition, it should be noted that any features or combinations of features of the individual embodiments may be present either individually or in combination with other features of the respective other embodiments.

### LIST OF REFERENCE NUMBERS

1 Fuel cell apparatus
2 Fuel cell
3 Cathode region
4 Anode region
5 PEM
6 Housing
7 Free space
8 Reservoir
9, 10 Supply line
11 Discharge line
12 Air filter
13 Compressor
14 Motor
15 Exhaust line
16 Separator
17 Flushing medium supply line
18 Branch point
19 Unit
20 Bypass line
21 Termination
22 Device
23 Logic and/or control unit
24 Medium discharge line
25 Termination
26 Branch line
27 Branch point
28 Unit

1. A fuel cell apparatus with at least one fuel cell (2) having an anode region (4) and a cathode region (3) and being accommodated in a housing (6), wherein a flushing medium for flushing the housing (6) can be introduced into a space (7) of the housing (6) outside the fuel cell (2), wherein the flushing medium is an exhaust gas generated in the cathode region (3) in the operation of the fuel cell (2).

2. The fuel cell apparatus according to claim 1, further including a device (22) for detecting the fuel concentration in the free space (7) of the housing (6) outside the fuel cell (2).

3. The fuel cell apparatus according to claim 2, wherein the device (22) is located within the housing (6) and outside the fuel cell (2).

4. The fuel cell apparatus according to claim 1, wherein the cathode exhaust gas can be introduced into the housing (6) in a situation-specific manner, in particular in dependence on the fuel concentration in the housing (6) outside the fuel cell (2).

5. The fuel cell apparatus according to claim 1, wherein a flushing medium supply line (17) branches off an exhaust line (15) of the cathode region (3) and terminates into the housing (6).

6. The fuel cell apparatus according to claim 5, wherein the flushing medium supply line (17) branches off the exhaust line (15) downstream of a separator (16) connected to the exhaust line (15) of the cathode region (3) as viewed in the direction of flow of the exhaust gas of the cathode region (3).

7. The fuel cell apparatus according to claim 6, wherein a bypass line (16) terminating into the exhaust line (15) downstream of the point (18) where the flushing medium supply line (17) branches off the exhaust line (15) of the cathode region (3) branches off the separator (16).

8. The fuel cell apparatus according to any of claims 5, wherein the flushing medium supply line (17) runs within the housing (6), preferably completely within the housing (6), outside the fuel cell (2).

9. The fuel cell apparatus according to claim 5, wherein the flushing medium supply line (17) branches off the exhaust line (15) outside the housing (6) and runs outside the housing (6).

10. The fuel cell apparatus according to claim 6, wherein the separator (16) is located within the housing (6).

11. The fuel cell apparatus according to claim 6, wherein the separator (16) is located outside the housing (6).

12. The fuel cell apparatus according to claim 5, wherein a unit (19) for reducing the flow cross-section, preferably a valve, is provided in the flushing medium supply line (17).

13. The fuel cell apparatus according to claim 12, wherein the unit (19) and the device (22) for detecting the fuel concentration are connected to a logic and/or control unit (23) in a manner suitable for conducting signals or data.

14. The fuel cell apparatus according to claim 1, wherein a medium discharge line (24) for discharging the medium mixture in the space (7) of the housing (6) terminates into a supply line (11) for the supply of oxidant to the cathode region (3).

15. The fuel cell apparatus according to claim 14, wherein the medium discharge line (24) terminates into the supply line (11) upstream of a handling unit (13) connected to the supply line (11), preferably a compressor, as viewed in the direction of oxidant flow.

16. The fuel cell apparatus according to claim 1, wherein a branch line (26) branches off the supply line (11) leading to the cathode region (3) and terminates into the housing (6) outside the fuel cell (2).

17. The fuel cell apparatus according to claim 16, wherein the branch line (26) runs completely within the housing (6).

18. The fuel cell apparatus according to claim 16, wherein the branch line (26) branches off the supply line (11) outside the housing (6) and terminates into the housing (6) from the outside.

19. The fuel cell apparatus according to claim 16, wherein the branch line (26) branches off the supply line (11) downstream of a handling unit (13) connected to the supply line (11).

20. The fuel cell apparatus according to claim 16, wherein a unit (28) for reducing the flow cross-section is provided in the branch line (26).

21. A method for the operation of a fuel cell apparatus (1) with at least one fuel cell (2) having an anode region (4) and a cathode region (3) and being accommodated in a housing (6), comprising:
generating an exhaust gas in the cathode region (3) in the operation of the fuel cell (2) as a flushing medium, and
introducing the exhaust gas generated in the cathode region (3), as a flushing medium for flushing a space (7) of the housing (6), wherein the flushing medium is introduced into the housing (6) outside the fuel cell (2).

22. The method according to claim 21, wherein the cathode exhaust gas is introduced into the housing (6) in terms of volume and/or time in dependence on a fuel concentration detected outside the fuel cell (2) in the housing (6).
